(19) United States
(12) Patent Application Publication
(10) Pub. No.: US 2023/0366700 A1
(43) Pub. Date: Nov. 16, 2023

(54) OVERLAY RENDERING USING A HARDWARE-ACCELERATED FRAMEWORK FOR MEMORY SHARING AND OVERLAY BASED MAP ADJUSTING

(71) Applicant: Apple Inc., Cupertino, CA (US)

(72) Inventors: Yunwei Zhang, Redwood City, CA (US); Jason K. Aftosmis, Berkeley, CA (US); Jeffrey Meininger, San Francisco, CA (US); Josiah W. Larson, Union City, CA (US); Nalini Shah, Cupertino, CA (US); Yingxiu Lu, Sunnyvale, CA (US); Christian Schroeder, Palo Alto, CA (US)

(73) Assignee: Apple Inc., Cupertino, CA (US)

(21) Appl. No.: 18/100,956

(22) Filed: Jan. 24, 2023

Related U.S. Application Data
(60) Provisional application No. 63/340,390, filed on May 10, 2022.

(51) Int. Cl. G01C 21/00; G06T 17/05; H04N 5/265; G06F 3/14; G01C 21/36

(52) U.S. Cl. CPC G01C 21/3878; G06T 17/05; H04N 5/265; G06F 3/14; G01C 21/367

(57) ABSTRACT

Third-party overlay data that includes customized graphics such as animations may be rendered on a base map using a hardware-accelerated framework. When third-party overlay data is deemed incompatible with a first version of a base map, features of the base map may be flexed to better accommodate the overlay data.

### CROSS-REFERENCES TO RELATED APPLICATIONS

This application claims priority to U.S. Provisional Patent Application No. 63/340,390, entitled “OVERLAY RENDERING USING A HARDWARE ACCELERATED FRAMEWORK FOR MEMORY SHARING AND OVERLAY BASED MAP ADJUSTING,” filed on May 10, 2022, the contents of which are hereby incorporated by reference in their entirety for all purposes.

### BACKGROUND

Digital maps such as those available via mobile and web applications typically include a base map (e.g., satellite, terrain, roads, etc.) within a map view. The base map may include two-dimensional features and three-dimensional features. To augment the base map, overlays may be added to the map view. For example, navigation instructions may include a graphical portion (e.g., a polyline) that is displayed on top of the base map. Incompatibilities may arise between overlays and base maps, especially when such overlays are developed by entities different than the entity that maintains the base map. These incompatibilities may result in inconsistent, or even complete failure of, display of overlays in the base maps. Additionally, map designers may desire to present certain features using more data-rich dynamic overlays such as animations, especially, on portable user devices. Using existing rendering techniques on existing user devices to render such data-rich overlays may strain processing capabilities of these existing user devices.

### BRIEF SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer-implemented method. The computer-implemented method includes requesting a surface texture corresponding to a map tile visible in a map view, the surface texture defining a rendering target for presenting a graphical overlay in connection with the map tile, the surface texture being shared via a shared memory. The computer-implemented method also includes drawing the graphical overlay into the surface texture using the shared memory to define an overlay surface texture that includes the graphical overlay. The computer-implemented method also includes providing the overlay surface texture for presenting the graphical overlay in the map tile in the map view. Other embodiments of this aspect include corresponding computer systems, apparatus, and computer programs recorded on one or more computer storage devices, each configured to perform the actions of the methods.

Another general aspect includes a computer-implemented method. The computer-implemented method includes providing a surface texture corresponding to a map tile visible in a map view, the surface texture defining a rendering target for presenting a graphical overlay in connection with the map tile, the surface texture accessible via a shared memory. The computer-implemented method also includes accessing an overlay surface texture defined by a client application drawing the graphical overlay into the surface texture using the shared memory, the overlay surface texture including the graphical overlay. The computer-implemented method also includes presenting the graphical overlay in connection with the map tile in the map view using the overlay surface texture. Other embodiments of this aspect include corresponding computer systems, apparatus, and computer programs recorded on one or more computer storage devices, each configured to perform the actions of the methods.

Another general aspect includes a computer-implemented method. The computer-implemented method includes determining a first version of a map view to render on a display of a user device based at least in part on map configuration data. The computer-implemented method also includes receiving overlay data for rendering an overlay on the map view. The computer-implemented method also includes determining, from the overlay data, one or more overlay properties. The computer-implemented method also includes changing the map view from the first version to a second version based on the one or more overlay properties. The computer-implemented method also includes rendering, on the display of the user device, a second version of the map view, the second version including the overlay. Other embodiments of this aspect include corresponding computer systems, apparatus, and computer programs recorded on one or more computer storage devices, each configured to perform the actions of the methods.

### BRIEF DESCRIPTION OF THE DRAWINGS

FIG. 1A illustrates a block diagram and a flowchart showing a process for dynamic overlay rendering using a hardware-accelerated framework for memory sharing, according to at least one example.

FIG. 1B illustrates a block diagram and a flowchart showing a process for base map adjusting using overlay properties, according to at least one example.

FIG. 2 illustrates a block diagram showing an example architecture or system for dynamic overlay rendering using a hardware-accelerated framework for memory sharing and base map adjusting using overlay properties, according to at least one example.

FIG. 3 illustrates a diagram showing an example process for dynamic overlay rendering using a hardware-accelerated framework for memory sharing, according to at least one example.

FIG. 4 illustrates a sequence diagram showing a map engine and a client application of a user device that perform dynamic overlay rendering using a hardware-accelerated framework for memory sharing, according to at least one example.

FIG. 5 illustrates a flow chart showing an example process for dynamic overlay rendering using a hardware-accelerated framework for memory sharing, according to at least one example.

FIG. 6 illustrates a flow chart showing an example process for dynamic overlay rendering using a hardware-accelerated framework for memory sharing, according to at least one example.

FIG. 7 illustrates a diagram depicting a technique relating to base map adjusting using overlay properties, according to at least one example.

FIG. 8 illustrates a flow chart showing an example process for base map adjusting using overlay properties, according to at least one example.

FIG. 9 illustrates a flow chart showing an example process for base map adjusting using overlay properties, according to at least one example.

FIG. 10 illustrates an example architecture or environment configured to implement techniques described herein, according to at least one example.

### DETAILED DESCRIPTION

In the following description, various examples will be described. For purposes of explanation, specific configurations and details are set forth in order to provide a thorough understanding of the examples. However, it will also be apparent to one skilled in the art that the examples may be practiced without the specific details. Furthermore, well-known features may be omitted or simplified in order not to obscure the example being described.

Examples of the present disclosure are directed to, among other things, methods, systems, devices, and computer-readable media for overlaying animated data on a map. Conventional approaches for overlaying animated data on maps have multiple deficiencies, which are overcome by the technology described herein. Conventional techniques typically involved a map engine on the user device accepting overlay data from a developer (e.g., via an onboard application of the developer), and rendering that data on top of the map view. While such conventional techniques may be suitable for rendering certain features (e.g., polygons, polylines, etc.), when used to render raster data, vector data, and other rich data sets such as those used for animations, processing memory overload can occur. Such overloading results in slow loading of overlay data and slow frame rates for animations. Additionally, because of these limitations, only limited or very basic animations may be presented.

The described technology provides technical solutions to solve these technical problems of the conventional approaches. In particular, the described technology provides a performant, flexible, and safe system for third-party developers to overlay and animate their data on top of a map. This system, which may be implemented in a user device such as a smartphone, vends, at the beginning of each rendering frame, a surface texture for each map tile in view, into which an application developer can render their own data to be displayed on, or blended with, the data already present on the map. Unlike conventional approaches that may rely entirely on memory from a single processor for rendering, the described system is performant because the memory vended is hardware-accelerated accessible from both a central processing unit (CPU) and a graphics processing unit (GPU) of the user device. The described system is flexible because the application developer has freedom to choose between a variety of approaches (e.g., two-dimensional graphics, three-dimensional shaders, and other similar approaches) to render into the surface texture, and in a manner that is most suitable for their application. This flexibility allows developers to use richer data sets, including those that are raster-based, vector-based, and the like. Unlike conventional approaches that struggled to deliver animated overlay at a suitable frame rate, the technology described herein enables third-party applications to draw on the map view at a frame about equal to the frame rate at which a native map application renders its content (e.g., between 50 and 100 frames per second). However, in some examples, animations at less than 50 frames per second may nevertheless provide suitable results.

Turning now to a first particular example, in this example is provided a portable user device that includes a map engine and a client application configured to overlay animated data on a map. The map engine may support mapping services on the portable user device, which may include providing a map view within an application and within the client application and implementing techniques relating to overlaying animated data on a map in the map view. The client application may be a third-party application that uses the map engine to perform map-related functions. For example, the client application may be a weather application that uses the map engine to support rendering of a base map for a weather map and overlaying animations of weather-related information (e.g., weather patterns, heat maps, etc.). To begin generation of a first frame of an overlay animation, the client application may request that the map engine vend a set of surface textures to the client application. A surface texture may be a hardware-accelerated surface texture (e.g., a hardware-accelerated buffer that can be shared between GPU and CPU of portable user device) that functions as the application's render target. The set of surface textures may correspond to the number of map tiles present in the current view. The client application may then render the first frame of its animation overlay into the set of surface textures, which are then returned to the map engine. The map engine may then use the surface textures to render the first frame of the overlay animation on the map view using its typical rendering technique (e.g., similarly as it would with a raster overlay provided by the map engine). This approach is then repeated iteratively for the next frame and the corresponding next set of visible map tiles. In some implementations, surface textures can be reused on multiple map tiles.

Other examples of the present disclosure are directed to, among other things, methods, systems, devices, and computer-readable media for dynamic rendering of a map based on user-supplied overlay data. Advancements in map generation in recent years has resulted in more detailed and data-rich base layer maps. For example, such base layer maps may, as a standard, include three-dimensional features (e.g., bridges, buildings, hills, etc.). These features create a three-dimensional simulation of our three-dimensional real world. While these features do provide an enhanced view of the world when used alone (e.g., a map view that includes only a base map) and/or in connection with certain standard native overlays (e.g., overlays that are specifically designed for use with enhanced base maps), developer-provided overlays that are not specifically designed for use with such enhanced maps may result in rendering errors that are distracting, nonsensical, and/or should otherwise be avoided.

The described technology provides technical solutions to solve these technical problems of the conventional approaches. In particular, the described technology describes a system in which, when a user desires to render an overlay in an enhanced map, the base map adapts its rendering to best accommodate that user-supplied data. Such accommodations can include collapsing some three-dimensional elements. For example, if a user supplies two-dimensional polygonal overlay data, the system may collapse some three-dimensional features (e.g., terrain elevation) of the three-dimensional map to best accommodate the two-dimensional data. In some examples, such accommodations may include draping a two-dimensional overlay across the three-dimensional features of the three-dimensional map. For example, if a user supplies a two-dimensional polyline overlay, the system may drape the overlay across the three-dimensional features of the map, rather than collapsing the features. As user-provided overlays (or other features) are added or removed, the system may animate various portions of the base map between their two-dimensional and three-dimensional states.

Turning now to a second particular example, in this example is provided a portable user device that includes a map engine configured to render a base map and overlays on the base map. The map engine may render overlays within third-party applications and/or overlays received from such third-party applications. These overlays may occasionally be referred to as user-provided overlays to distinguish from overlays that are included within native applications on the portable user device (e.g., a map app). The map engine may receive a request to render an overlay on a base map. The map engine may compare properties of the current base map with properties of the overlay to determine compatibility of the two data sets. This may include referencing a set of rendering rules that describe, given certain properties of each data set, how the current base map will be modified. In some examples, such properties may include data availability within the base map. For example, flexing may vary by region, e.g., flexing may occur in a boundary region as a user enters the region with available data. In some examples, such properties may include overlay type. For example, the presence of overlays without elevation data may result in flexing that flattens the base map. When such overlays are removed and/or are no longer within the current view, the base may be restored to its elevated version. As an additional example, overlays with elevation data, such as overlays provided by a service provider's routing service, may not result in flexing of the base map because the base map has three-dimensional properties. Such modifications may include flexing features of the current base map, flexing portions of the current base map, and/or flexing the entirety of the current base map. In some examples, the current base map may not be flexed. Instead, the overlay data may draped onto the current base map (e.g., using a projection function).

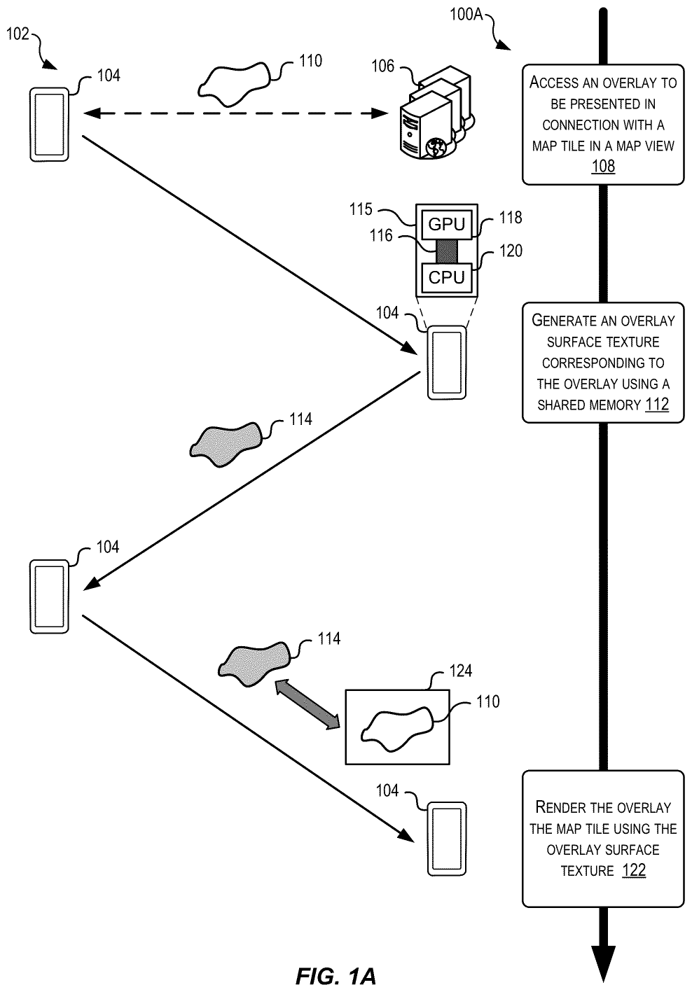

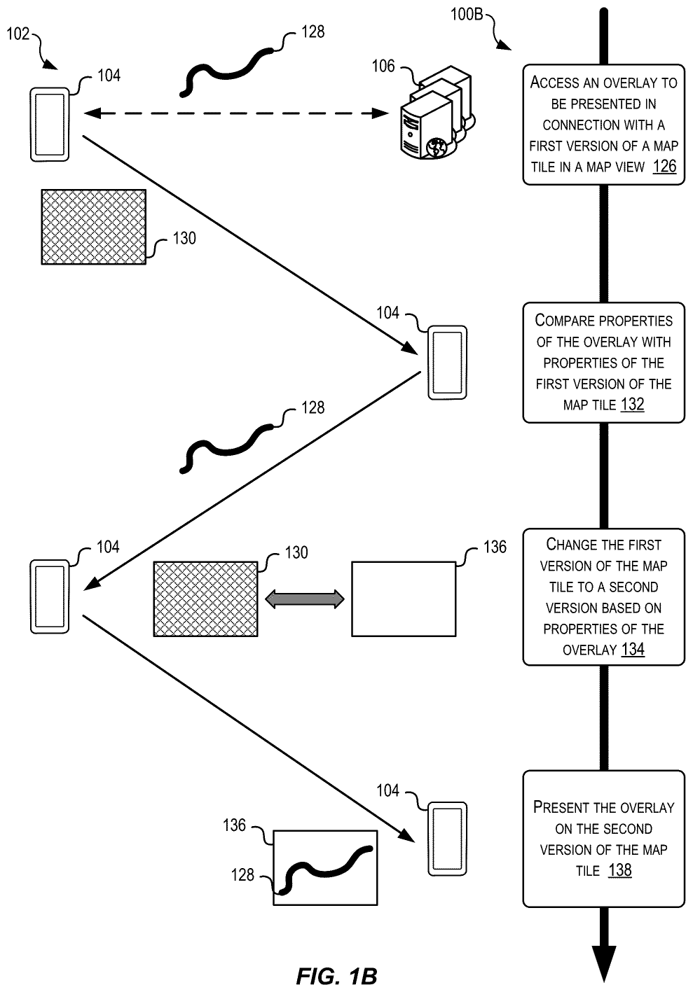

Turning now to the figures, FIG. 1A illustrates a block diagram 102 and a flowchart showing a process 100A for dynamic overlay rendering using a hardware-accelerated framework for memory sharing, according to at least one example. The block diagram 102 includes a user device 104 and a source 106 that participate in the process 100A. The user device 104 is any suitable electronic user device such as, for example, a handheld, portable, or other user device, a laptop, a smartphone, a smartwatch, a wearable electronic device, and/or any other suitable electronic device capable of displaying content (e.g., map views). The source 106 is any suitable combination of computing devices such as one or more server computers, which may include virtual resources, capable of performing the functions described with respect to the source 106. For example, the source 106 may include one or more different servers and/or services directed to serving content to the user device 104.

FIGS. 1A, 1B, E, 4-6, 8, and 9 illustrate example flow diagrams showing processes 100A, 100B, 300, 400, 500, 600, 800, and 900, according to at least a few examples. These processes, and any other processes described herein, are illustrated as logical flow diagrams, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

The process 100A begins at block 108 by the user device 104 accessing an overlay 110 to be presented in connection with a map tile 124 in a map view. The user device 104 may access the overlay 110 from the source 106 via a series of communications. In some examples, the user device 104 may access the overlay 110 from memory of the user device 104. The overlay 110 may include any suitable data that may be presented in the map view. For example, the overlay 110 may be a feature (e.g., polyline, polygon, etc.), raster data set, vector data set, and any other suitable data. In some examples, the overlay 110 may be configured to present an animation in the map view. Thus, the overlay 110 may include a series of time-aligned frames. The overlay 110 may have been developed by a third-party (e.g., a first entity that is separate from a second entity that developed the operating systems and/or applications that are native to the user device 104). Because of this limitation, the way in which the overlay 110 is rendered by the user device 104 may be different than if the overlay were developed by the second entity. For example, applications developed by the second entity may have access to additional hardware of the user device 104 for rendering. The second entity may develop the user device 104 in a manner that prevents granting such full access to untrusted third-party applications. The approaches described herein enable the user device 104 to safely and effectively render developer-supplied overlays in a way that gives the developer's application access to additional hardware resources for rendering, while letting the developer be responsible for performance.

At block 112, the process 100A includes the user device 104 generating an overlay surface texture 114 corresponding to the overlay using a hardware-accelerated framework for memory 115. The overlay surface texture 114 may be generated by the user device 104 using the hardware-accelerated framework for memory sharing 115 to draw the overlay into a set of surface textures that are vended by a map engine on the user device 104. The hardware-accelerated framework for memory sharing 115 may provide a framework for a graphics processing unit (GPU) 118 and a central processing unit (CPU) 120 of the user device 104 to share memory resources 116. Thus, resources from the GPU 118 and CPU 120 may be used to draw the overlay into set of surface textures using shared memory resources 116, which can then (at block 122) be added to the map view in the same way, as if the overlay were created by the second entity.

At block 122, the process 100A includes the user device 104 rendering the overlay 110 on map tile 124 using the overlay surface texture 114. This may include the user device 104 adding the overlay 110 as a raster overlay or other suitable overlay, depending on the properties of the overlay 110. In some examples, the block 122 also includes blending the overlay 110 with the map tile 124.

FIG. 1B illustrates the block diagram 102 and a flowchart showing a process 100B for base map adjusting using overlay properties, according to at least one example. The process 100B may be implemented using at least some of the same elements as the process 100A.

The process 100B begins at block 126 by the user device 104 accessing an overlay 128 (an example of the overlay 110) to be presented in connection with a first version of a map tile 130 (an example of the map tile 124) in a map view. For example, the map view may be presented in an application on the user device 104. In practice, the overlay 128 may be accessing in a manner similar to block 108. In some examples, the overlay 128 may be accessed from a routing engine, and the overlay 128 may be polylines and navigation instructions. Other examples of the overlay 128 are described herein.

The first version of the map tile 130 may have certain first properties. For example, in a particular example, the first version of the map tile 130 may be part of an enhanced three-dimensional map that includes three-dimensional features (e.g., roads, buildings, bridges, hills, and the like). At block 132, the user device 104 may compare properties of the overlay 128 with properties of the first version of the map tile 130. This comparison may be performed to determine whether the overlay 128 may be presented in connection with the first version of the map tile 130.

If the combination would be unsuitable (e.g., if the overlay 128 would not project correctly in the enhanced three-dimensional map), the user device 104, at block 134, may change the first version of the map tile 130 to a second version of the map tile 136 based on properties of the overlay 128. This change may include changing certain features of the map tile 130 such that the map tile can better accommodate the overlay 128. This may include adding or removing features from the map tile 130 to result in the second version of the map tile 136. In some examples, this action of changing features of the map tile 130 may be referred to as “flexing” the map tile 130. In a particular example, if the properties of the overlay 128 indicated that the overlay was a two-dimensional polyline (without elevation data) and the map tile 130 was an enhanced three-dimensional tile, the user device may change the map tile 130 to be a two-dimensional tile (e.g., remove three-dimensional features). Such a change may enable the two-dimensional polyline to overlay at a “zero” elevation on the map. If not, the two-dimensional polyline may not overlay correctly on the three-dimensional features.

After the change at block 134, the process 100B includes, at block 138, the user device 104 presenting the overlay 128 on the second version of the map tile 136. This may include presenting the overlay 128 using any suitable presentation technique.

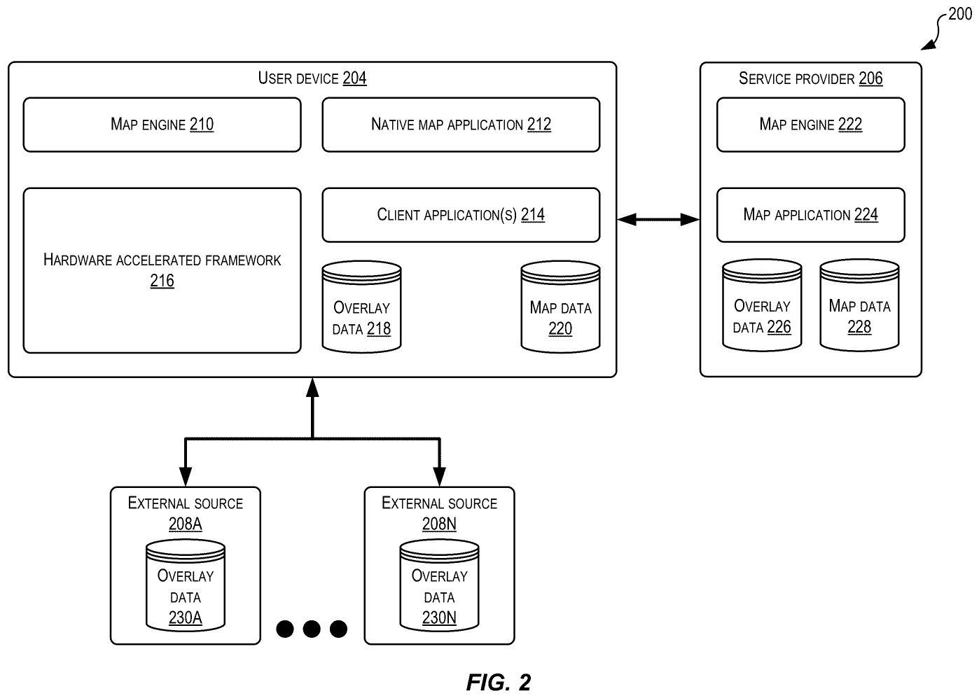

FIG. 2 illustrates a block diagram showing an example architecture or system 200 for dynamic overlay rendering using a hardware-accelerated framework for memory sharing and base map adjusting using overlay properties, according to at least one example. The system 200 includes a user device 204 (e.g., the user device 104), a service provider 206, and one or more external sources 208A-208N. The service provider 206 and the external sources 208 are examples of the source 106 described herein.

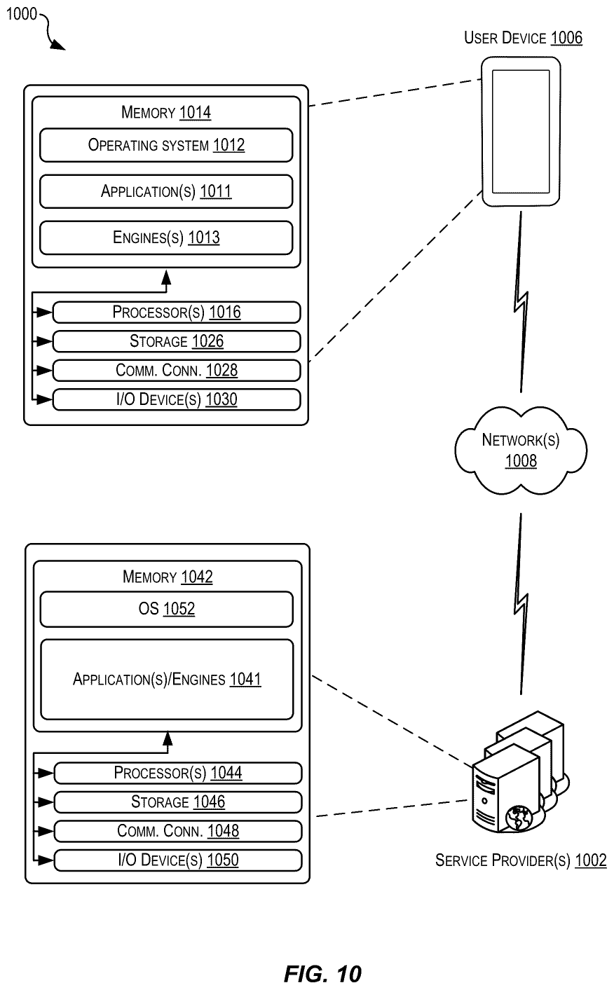

Beginning with the user device 204, the user device 204 includes a map engine 210, a native map application 212, client application(s) 214, a hardware-accelerated framework 216, a database for overlay data 218, and a database for map data 220. The user device 204 may also include other conventional elements to implement the techniques described herein such as those shown in FIG. 10.

Generally, the map engine 210 may be configured to render maps-related objects within the native map application 212 and the client applications 214. The map engine 210 may provide an application programming interface (API) on the user device 204 that makes it easy for applications to display maps, mark locations, provide enhancements with custom data and even draw routes or other shapes on top of the underlying base map. As described with reference to later figures, the map engine 210 may support rendering of user-supplied overlay data in a map view. The map engine 210 may also vend the surface textures described herein to allow the client applications 214 to draw more complex graphical overlays (e.g., animations, etc.) into the map view.

The native map application 212 is a maps-focused application that is native to the user device 204 (e.g., developed by the same entity that developed the OS for the user device 204). In this manner, the native map application 212 may be enabled to perform the functions described herein by interacting with the map engine 210. In some examples, native map application 212 may be configured to enable client applications 214 to present overlays therein. In some examples, the overlays presented in the native map application 212 may be those that are specifically designed and developed by the native map application developer for presentation in the native map application 212. In some examples, the native map application 212 alone, or in connection with the map engine 210, may be capable of generating navigation instructions (e.g., walking instructions, driving instructions, public transit instructions, biking instructions, etc.).

The client applications 214 may be developed by third-parties, i.e., entities other than the developer of the native map application 212 and the OS of the user device 204. In some examples, the developer of the OS may provide software development kits (SDKs) to enable the developers of the client applications 214 to utilize the services of the map engine 210, including those described herein. In some examples, the client applications 214 may include map-based elements that could benefit from the techniques described herein. Examples of such map-based elements include a weather application with a weather map, a routing or navigation map, a map to show location of rental bikes within a city, a map showing voting districts, a heat map showing prevalence of a disease in different regions, a map showing demographics of a settlement, and any other map-based elements.

The hardware-accelerated framework 216 may provide a framebuffer object suitable for sharing across process boundaries. For example, the hardware-accelerated framework 216 may allow the client applications 214 to move complex image decompression and draw logic into a separate process to enhance security and improve computing. The hardware-accelerated framework 216 may also enable sharing of buffer data (e.g., framebuffers and textures) across multiple processes in a way that manages memory more efficiently. In particular, the hardware-accelerated framework 216 may enable the user device 204 to use memory shared between the GPU and CPU of the user device 204 for performing the techniques described herein.

The overlay data 218 may include data suitable for overlaying on a base map. The map data 220 may include data sets suitable for generating base maps (e.g., three-dimensional, two-dimensional, satellite, road, terrain, and/or any suitable combination of these and/or similar maps).

Turning now to the service provider 206, generally, the service provider 206 may be formed from one or more remote servers, which may be virtual, and are configured to perform the techniques described herein. The service provider 206 includes a map engine 222, a map application 224, an overlay data database 226, and a map data database 228. The map engine 222 and the map application 224 may be examples of the map engine 210 and the native map application 212, but implemented at the service provider 206. Thus, in some examples, the user device 204 may communicate with the service provider 206 to perform the techniques described herein. The overlay data 226 is an example of the overlay data 218, and the map data 228 is an example of the map data 220.

The external sources 208A-208N represent any suitable source that may provide maps-related overlay data to the user device 204. For example, the external source 208A may be a map delivery server that serves maps-related data to the client application 214. To this end, the external sources may be any suitable computing device, any of which may include overlay data databases 230A-230N. The ellipsis is shown between the external source 208A and 208N to designate that more or fewer external sources 208 may be included in the system 200. The elements of the system (e.g., the user device 204, the service provider 206, and/or the external sources 208) may communicate with each other via one or more networks.

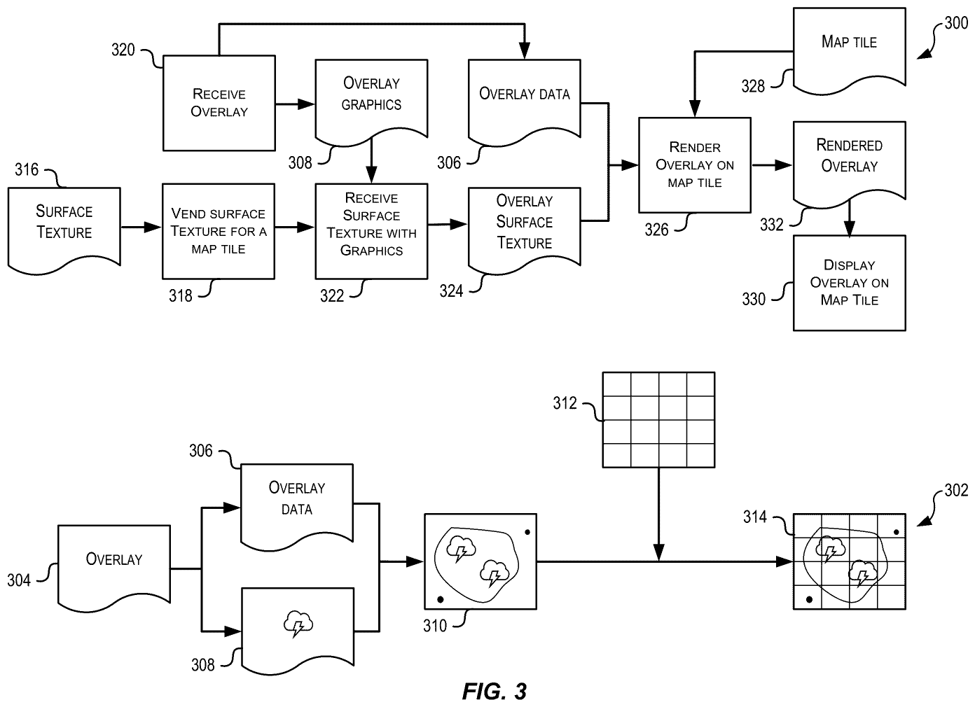

FIG. 3 illustrates a diagram showing an example process 300 for dynamic overlay rendering using a hardware-accelerated framework for memory sharing, according to at least one example. The process 300 may be implemented by the element(s) of the system 200, and the user device 204 in particular. The process 300, when performed, will result in a rendered animation on a map view, as graphically depicted as process 302. In the process 302, overlay data 304, which may include overlay configuration data 306 and overlay graphics 308, is combined into an animation 310. The animation 310 may then be added to a base map 312 having multiple tiles to result in finished animation 314 (e.g., the animation 310 has been overlaid on the base map 312). The process 300 performs the process 302 in a performant and flexible manner.

The process 300 includes, at block 318, the user device 204 vending a surface texture 316 for a map tile. This may include making the surface texture 316 available for an application of the user device 204 to draw into the surface texture 316 using any suitable technique including shaders and the like. At block 320, the user device 204 receives an overlay, which includes overlay graphics 308 and overlay configuration data 306. At block 322, the user device 204 draws the overlay graphics 308 into the vended surface textures 316 (e.g., one surface texture for each map tile and frame of the graphics) to create an overlay surface texture 324. The overlay surface texture 324 represents a surface texture that includes the overlay graphics defined therein. Block 322 may be performed using the hardware-accelerated framework 216 described herein. At block 326, the overlay configuration data 306 is used to render the overlay data 304 on a map tile 328 using the overlay surface texture 324 to define a rendered overlay 332. At block 330, the user device 204 displays the rendered overlay 332 on the map tile 328 (e.g., in a map view on the user device 204).

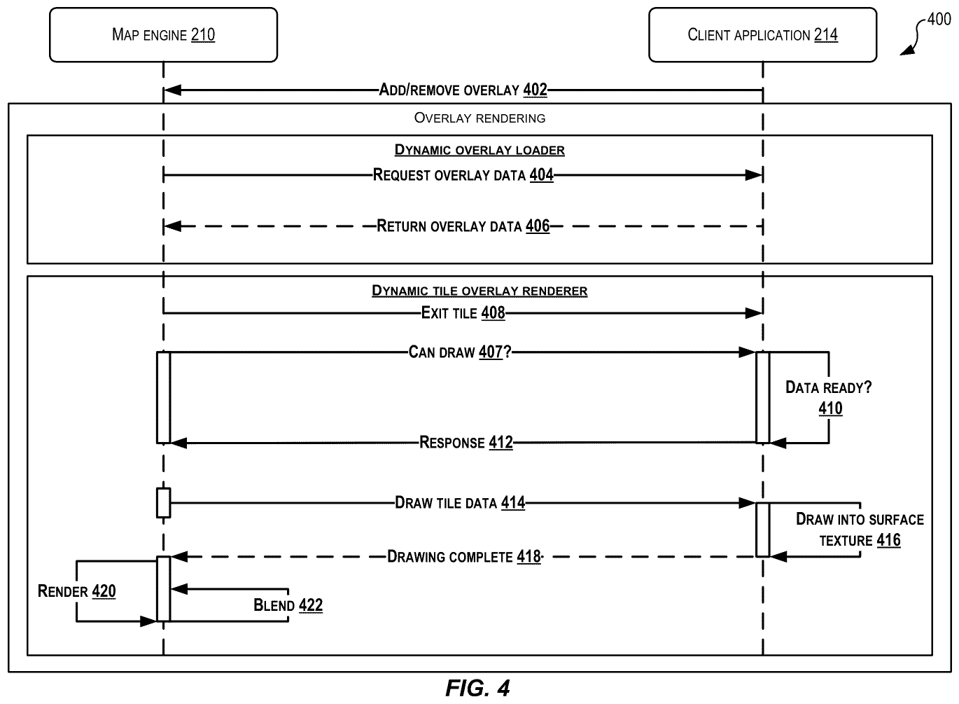

FIG. 4 illustrates a sequence diagram 400 showing the map engine 210 and a client application 214 of the user device 204 that perform dynamic overlay rendering using a hardware-accelerated framework for memory sharing, according to at least one example. The sequence diagram 400 includes an overlay rendering portion, which uses a dynamic overlay loader subclass and a dynamic tile overlay renderer subclass to implement overlay rendering. In the sequence diagram 400, the client application 214 manages adding/removing overlays, as shown at action 402. Action 402 may include the client application 214 sending a request to the map engine 210, requesting the map engine 210 to add an overlay or remove the overlay. Action 402 may trigger the overlay rendering portion of the sequence diagram 400.

The dynamic overlay loader subclass may represent an interface by which the client application 214 will provide its own overlay data that form the overlay to be rendered. Action 404 includes the map engine 210 requesting the overlay data from the client application 214. In response, the client application 214 may return the overlay data at action 406. Actions 404 and 406 may be performed asynchronously and for each visible map tile. When the map view changes and different map tiles are visible, actions 404 and 406 may be performed for portions of the overlay corresponding to those map tiles.

The dynamic tile overlay renderer subclass may be implemented by the map engine 210 and may be responsible for how to render the supplied overlay data. Action 408 may be performed for tiles that have exited the map view. In particular, at action 408, the client application 214 may purge and/or otherwise delete cached data relating to overlays that can be presented. The next set of actions may be performed for all visible tiles. Action 407 includes the map engine 210 checking if the client application 214 is ready to draw into a surface texture. Action 408 includes the client application 214 determining whether the overlay data is ready to draw. If yes, the client application 214 returns a positive response, at action 412, to the map engine 210. The map engine 210, at action 414, then provides the client application 214 with a path to a surface texture to which the client application 214 can draw the overlay data. At action 416, the client application 214 draws the overlay data into the surface texture at the path. This may include using existing drawing frameworks/shaders and/or code that is based on these such as Core Graphics or Metal provided by Apple Inc. of Cupertino, CA (e.g., ones suitable for handling path-based drawing, antialiased rendering, gradients, images, color management, offscreen rendering, patterns, shadings, image creation, image masking, three-dimensional environments, access to GPU to render computational tasks in parallel, etc.). In some examples, the approaches described herein may be especially useful to allow the client application 214 to draw overlays using its own shaders, rather than those provided by a service provider. For example, the approaches described herein may enable the client application to use a platform-optimized, low-overhead API for developing three-dimensional and two-dimensional overlays using a rich shading language with integration between graphics and compute programs (e.g., use of shared memory). This API may allow managing ever more complex shader code, with a suite of advanced GPU debugging tools to enable developers of the client application 214 to realize the full potential of their own graphics code.

The client application 214, at action 418, then informs the map engine 410 that it has completed drawing to the surface texture. Following action 418, the map engine at action 420 renders the overlay data into the map tile using the overlay data that has been drawn into the surface texture. Likewise at action 422, the map engine 210 may blend the overlay data into the map tile using the overlay data that has been drawn into the surface texture. The actions 414, 416, and 418 may be performed using the hardware-accelerated framework 216 described herein with shared resources of the user device 204.

In some examples, a multi-threaded process may be used for rendering base map tiles and overlays, as described herein. For example, the map engine 210 may collect all the visible tiles with a current position. If any of those tiles have not been loaded, the map engine 210 will begin to download those tiles. The map engine 210 may also collect the downloaded resources into containers for later use in rendering. On a background thread, the map engine 210 may perform action 414 to cause the client application 214 to begin to draw the overlay data into surface textures for each tiles, as that data becomes available. The base map rendering continues in another higher priority thread, but may be synced when it is finished drawing all the other map content. The synchronization may wait for the base map thread to finish drawing, if it has not done so already, and then blend the surface textures with the rendered base map.

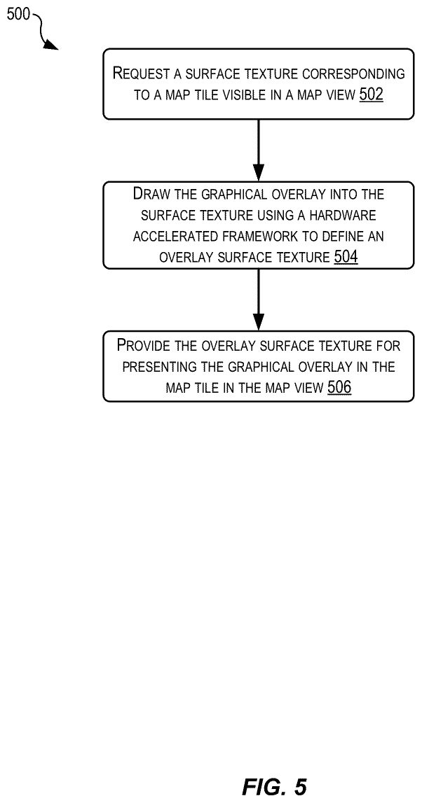

FIG. 5 illustrates a flow chart showing an example process 500 for dynamic overlay rendering using a hardware-accelerated framework for memory sharing, according to at least one example. The process 500 may be performed by the user device 204 (FIG. 2). In particular, the process 500 may be performed by a client application 214 (FIG. 2) of the user device 204 (FIG. 2) in communication with the map engine 210 (FIG. 2) and using the hardware-accelerated framework 216 (FIG. 2).

The process 500 begins at block 502 by the client application 214 requesting a surface texture corresponding to a map tile visible in a map view. The surface texture may define a rendering target for presenting a graphical overlay in connection with the map tile. The surface texture may be shared via the hardware-accelerated framework 216 to access the shared memory resources. In some examples, the graphical overlay may include graphics in the form of a series of frames, and the surface texture may correspond to a first frame and the map tile. In some examples, a set of surface textures may be requested for a set of visible map tiles. The series of frames may represent an animation. In some examples, the graphical overlay may include a portion of a graphical animation. In some examples, a ratio of surface textures to map tiles may be 1:1.

The hardware-accelerated framework 216 may enable access to a memory of the user device that is shared between a graphics processing unit of the user device and a central processing unit of the user device. In some examples, the shared memory may be a memory of a user device that is shared by the client application 214 and the map engine 210.

In some examples, the process 500 may further include the client application 214 receiving a request to add the graphical overlay to the map view. For example, a user may use an input component of the user device 204 to request that the graphical overlay be loaded into the map view.

In some examples, the process 500 may further include the client application 214 requesting the graphical overlay from an overlay source. The overlay source may be a remote server configured to deliver content such as one of the external sources 208A-208N, described herein. The overlay source may include an animation, vector data, raster data, and/or any other suitable data. In some examples, the overlay source may be the same as a source of the map tile. For example, a service provider content server associated with the user device may serve the graphical overlay and the map tile.

In some examples, requesting the surface texture may include requesting, by the client application 214 on the user device, the surface texture from the map engine 210 accessible on the user device.

At block 504, the process 500 includes the client application 214 drawing the graphical overlay into the surface texture using the hardware-accelerated framework 216 to define an overlay surface texture. The overlay surface texture may include the graphical overlay. This may include the client application 214 drawing a first frame of the graphical overlay into a first surface texture using the hardware-accelerated framework 216 and repeating iteratively for additional frames into additional surface textures.

At block 506, the process 500 includes the client application 214 providing the overlay surface texture for presenting the graphical overlay in the map tile in the map view. In some examples, providing the overlay surface texture may include providing the overlay surface texture to the map engine 210 for the map engine to present the graphical overlay in the map tile in the map view.

In some examples, providing the overlay surface texture may include providing the overlay surface texture to the map engine 210 on the user device. The map engine 210 may be configured to render the graphical overlay on top of the map tile.

In some examples, providing the overlay surface texture may include providing the overlay surface texture to the map engine 210 on the user device. The map engine 210 may be configured to blend the graphical overlay with the map tile.

In some examples, providing the overlay surface texture may include providing the overlay surface texture to the map engine 210 of a user device. The map engine 210 is configured to use the overlay surface texture to draw the graphical overlay on the map tile in the map view.

In some examples, the surface texture may be a first surface texture, the map tile may be a first map tile, the rendering target may be a first rendering target, and the graphical overlay may include a first portion and a second portion. In this example, the process 500 may further include requesting a second surface texture corresponding to a second map tile visible in the map view. The second surface texture may define a second rendering target for presenting a second portion of the graphical overlay in connection with the second map tile. In some examples, drawing the graphical overlay into the surface texture may include drawing the second portion of the graphical overlay into the second surface texture using the shared memory to define a second overlay surface texture that includes the second portion of the graphical overlay. In some examples, providing the overlay surface texture for presenting the graphical overlay may include providing the second overlay surface texture for presenting the second portion of the graphical overlay in the second map tile in the map view.

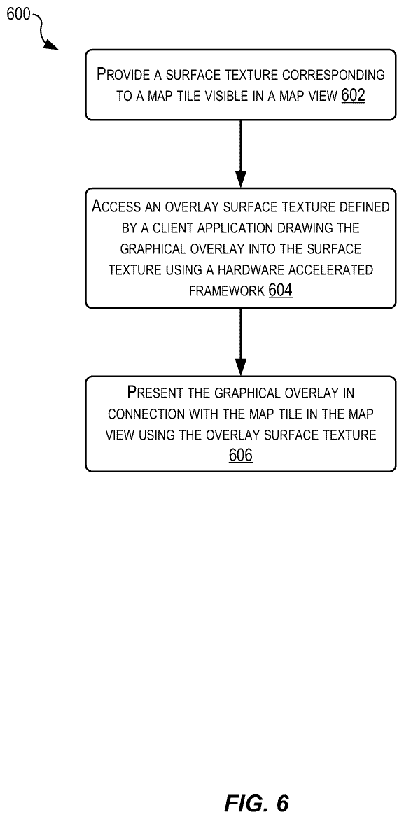

FIG. 6 illustrates a flow chart showing an example process 600 for dynamic overlay rendering using a hardware-accelerated framework for memory sharing, according to at least one example. The process 600 may be performed by the user device 204 (FIG. 2). In particular, the process 600 may be performed by a map engine 210 (FIG. 2) of the user device 204 (FIG. 2) in communication with the client application 214 (FIG. 2) and using the hardware-accelerated framework 216 (FIG. 2).

The process 600 begins at block 602 by the map engine 210 providing a surface texture corresponding to a map tile visible in a map view. The surface texture may be provided to the client application in response to a request received from the client application. The surface texture may define a rendering target for presenting a graphical overlay in connection with the map tile. The surface texture may be accessible via the hardware-accelerated framework 216 (e.g., the shared memory). In some examples, providing the surface texture may include providing, by the map engine 210 accessible on the user device, the surface texture to the client application 214 of the user device.

In some examples, the process 600 may further include receiving a request for the surface texture. In some examples, providing the surface texture may include providing the surface texture in response to receiving the request. In some examples, receiving the request may include receiving the request, by the map engine 210 of the user device, from the client application 214 of the user device.

In some examples, the process 600 may further include receiving a request to add the graphical overlay to the map view. In some examples, providing the surface texture may include providing the surface texture in response to receiving the request to add the graphical overlay. In some examples, the request may be based on a user input received by the user device.

At block 604, the process 600 includes the map engine 210 accessing an overlay surface texture defined by the client application drawing the graphical overlay into the surface texture using the shared memory. The overlay surface texture may include the graphical overlay. In some examples, the graphical overlay may include overlay graphics including a series of frames, vector data, and/or raster data.

At block 606, the process 600 may include the map engine 210 presenting the graphical overlay in connection with the map tile in the map view using the overlay surface texture. In some examples, presenting the graphical overlay in connection with the map tile in the map view using the overlay surface texture may include rendering the graphical overlay using the overlay surface texture. In some examples, presenting the graphical overlay in connection with the map tile in the map view using the overlay surface texture may include blending the graphical overlay using the overlay surface texture.

In some examples, the map tile may be one of a plurality of map tiles visible in the map view. In this example, individual surface textures may be provided for each of the plurality of map tiles. In some examples, the surface texture may be hardware-accelerated. In some examples, the shared memory may be shared between the map engine 210 and the client application 214. In some examples, the shared memory may be shared between a graphics processing unit and a central processing unit.

In some examples, presenting the graphical overlay may include rendering the graphical overlay on the map tile using overlay surface texture. In some examples, the overlay surface texture may be defined by the client application using one or more programmable shaders.

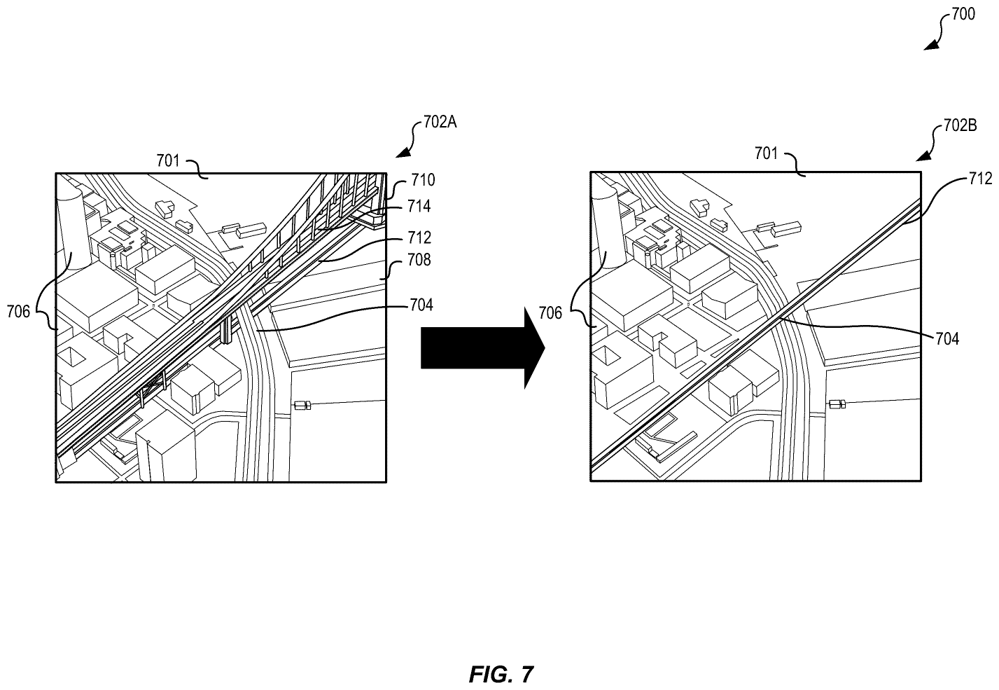

FIG. 7 illustrates a diagram 700 depicting a technique relating to base map adjusting using overlay properties, according to at least one example. The diagram 700 depicts a first base map version 702A and a second base map version 702B. The first base map version 702A has been modified using the techniques described herein, which has resulted in the second base map version 702B. The first base map version 702B may be represented by one or more base map tiles, e.g., depending on the zoom level associated with the base map 702 and/or resolution of the base map 702. The base map versions 702A, 702B depict similar map views of a city next to a water feature. The base map version 702A includes many different features, some of which are two-dimensional (e.g., water 701) and some that are three-dimensional (e.g., stacked roadways 704, buildings 706, pier 708, and bridge 710). These features provide additional context in the first base map version 702A and therefore constitute an enriched view.

The first base map version 702A also includes a three-dimensional routing line 714 and a two-dimensional routing line 712, both of which have been added to the first base map version 702A. As can be seen, the three-dimensional routing line 714, which may be a three-dimensional polyline or other suitable overlay, extends along the bridge 710 at the elevated location (i.e., above the water 701). Thus, the orientation of the three-dimensional routing line 714 is correct in all three axes. This may be because the three-dimensional routing line 714 includes elevation information that can be used to correctly overlay the routing line 714 at the correct elevation with respect to the other features in the first base map version 702A.

The two-dimensional routing line 712 has been added to the first base map version 702A without also flexing the base map using the techniques described herein to illustrate the benefit of such techniques. The two-dimensional routing line 712 may be a polyline that is presented in the base maps 702 as an overlay. As shown in the first base map version 702A, the two-dimensional routing line 712 may be oriented correctly in the X and Y axes, but because it does not have elevation information, it is shown extending below the bridge 710, below the stacked roadway 704, and through the pier 708. Thus, given the properties of the first base map version 702A (e.g., a three-dimensional map including three-dimensional roadways, etc.) and the properties of the two-dimensional routing line 712 (e.g., a two-dimensional polyline that does not include corresponding elevation values), display of the two-dimensional routing line 712 within the first base map version 702A is unsuitable.

Using the techniques described herein, certain features of the first base map version 702A may be flexed, changed, and/or otherwise adjusted to better accommodate the two-dimensional routing line 712. For example, the three-dimensional features of the map (or at least those near the two-dimensional routing line 712) may be adjusted to accommodate the two-dimensional routing line 712. In this particular example, the stacked roadway 704 has been changed to a two-dimensional road and the bridge 710 and the pier 708 have been entirely removed from the second base map version 702B. Similarly, other buildings near the two-dimensional routing line 712 have been removed to better view the two-dimensional routing line 712.

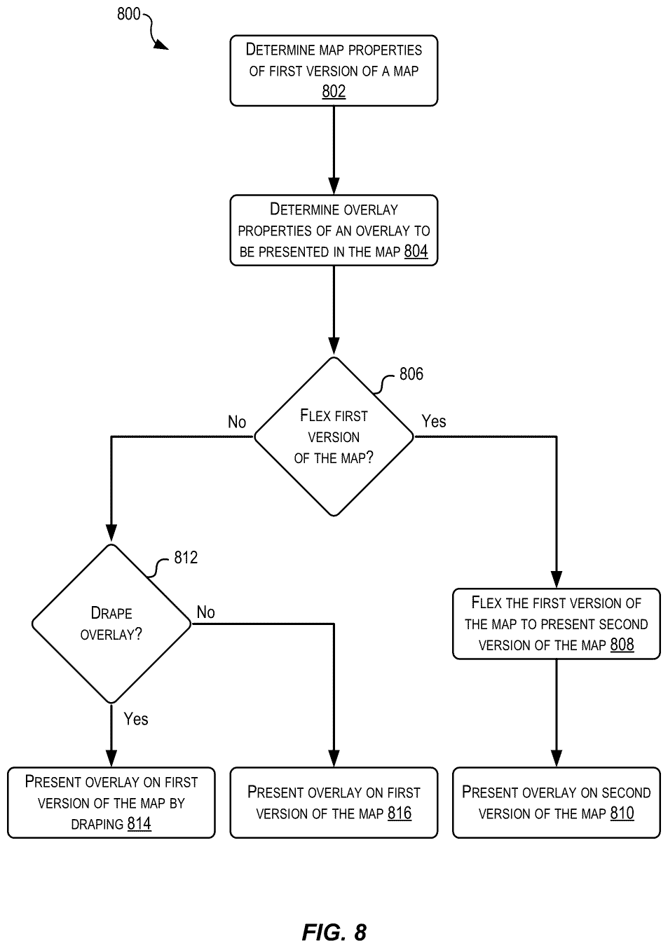

FIG. 8 illustrates a flow chart showing an example process 800 for base map adjusting using overlay properties, according to at least one example. The process 800 in particular may be performed by the map engine 210 (FIG. 2) of the user device 204 (FIG. 2) and/or of the service provider 206 (FIG. 2).

The process 800 begins at block 802 by the user device 204 determining map properties of a first version of a map. The map properties may be obtained by the user device 204 accessing them from an API or other service that maintains properties of the first version of the map, which may be the version currently displayed. The user device 204 may determine the map properties by accessing a data structure on the user device 204 that maintains the properties. Example properties may include a map type (e.g., satellite, street, terrain, hybrid, etc.), dimensionality of map and/or features (e.g., three-dimensional or two-dimensional), whether flexing is permitted with the map region, and any other suitable property relevant for determining whether the map is compatible with the overlay.

At block 804, the process 800 includes the user device 204 determining overlay properties of an overlay to be presented in the map. Determining the overlay properties may include requesting the overlay properties in the form of overlay configuration data from the client application or other application that is providing the overlay. In some examples, the overlay properties may accompany the overlay and/or may otherwise be capable of derivation from the overlay. In some examples, the process 800 may further include receiving the overlay, which may be performed in connection with block 804. The overlay properties may include an overlay type (e.g., line, polygon, raster, vector, etc.), dimensionality (e.g., two-dimensional or three-dimensional), and any other suitable property relevant for determining whether the overlay is compatible with the map.

At block 806, the process 800 includes the user device 204 determining whether to flex the first version of the map. Determining whether to flex the first version of the map may include comparing the properties from block 802 with the properties from block 804 to determine whether the overlay is compatible with the first version of the map. In some examples, a scoring framework may be used to compute compatibility. In some examples, because the universe of possible permutations may be low (e.g., less than 50), the rules for flexing the first version of the map may be hardcoded in the map engine. In this manner, when certain conditions are met, the user device 204 may operate accordingly.

If the answer at block 806 is yes, the process 800 continues to block 808. At block 808, the process 800 includes the user device flexing the first version of the map to present a second version of the map. Flexing the first version of the map may include flexing a portion of the map (e.g., a visible tile, a visible portion, certain features of the map, and any other portion that constitutes less than the map) or flexing all of the map. In some examples, flexing may include changing, adjusting, or otherwise flexing the map. In some examples, flexing may include flexing to increase richness of the map (e.g., adding more features and detail) and flexing to decrease richness of the map (e.g., removing features and detail). The second version of the map may be the resultant version after flexing. FIG. 7 depicts an example of flexing the map to remove certain features to better depict the overlay.

Following block 808, the process 800 includes, at block 810, the user device 104 presenting the overlay on the second version of the map. This may include the map engine rendering the overlay and map using techniques described herein. In some examples, the rendering described with respect to block 810 may be performed using the techniques described with respect to FIGS. 1 and 3-6.

If the answer at block 808 is no, the process 800 continues to block 812. At block 812, the process 800 determines whether to drape the overlay on the first version of the map. In some examples, the determination at block 812 may be based on a comparison of the properties, like block 806. In some examples, draping may be appropriate when the first version of the map is a three-dimensional map and the overlay can be placed on contours and other topmost portions of the map, with little impact on how the overlay looks. For example, when the overlay includes a set of points (e.g., a set of flags to identify points of interest, a set of points to identify bikes for rental in a city, etc.), the overlay may be properly draped over a three-dimensional map because the points may be projected onto a topmost surface of the map, and doing so will not impact the information to be conveyed by the set of points. Thus, if the answer at 812 is yes, the process 800 continues to block 814, at which the user device presents the overlay on the first version of the map by draping. If the answer at 812 is no, the process 800 continues to block 816, at which the user device presents the overlay on the first version of the map, i.e., without draping. For example, if the first version of the map were a two-dimensional map and the overlay were a two-dimensional overlay, then no flexing and no draping may be necessary.

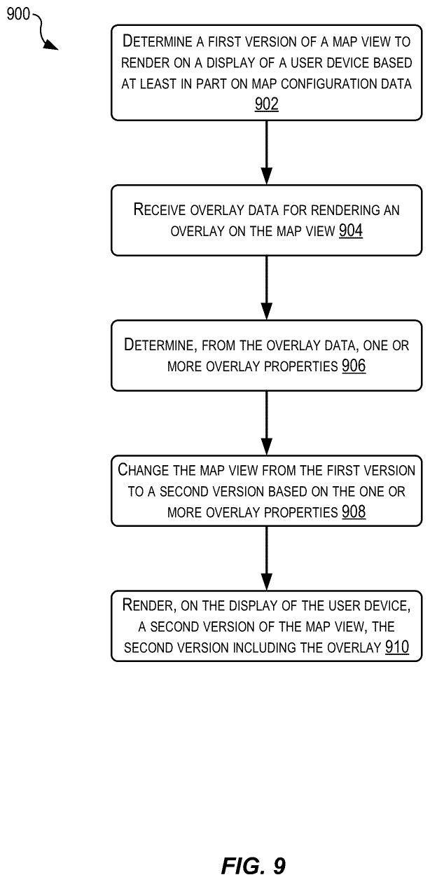

FIG. 9 illustrates a flow chart showing an example process 900 for base map adjusting using overlay properties, according to at least one example. The process 900 in particular may be performed by the map engine 210 (FIG. 2) of the user device 204 (FIG. 2) and/or of the service provider 206 (FIG. 2).

The process 900 begins at block 902 by the user device 204 determining a first version of a map view to render on a display of the user device based at least in part on map configuration data. The map configuration data may inform the user device 204 which map type to present.

At block 904, the process 900 includes the user device 204 receiving overlay data for rendering an overlay on the map view. In some examples, receiving the overlay data may include receiving the overlay data from a third-party source. In some examples, receiving the overlay data may include receiving the overlay data from a mapping service such as a map engine of a service provider. In some examples, receiving the overlay data may include receiving a user selection of the overlay for presentation in the map view.

At block 906, the process 900 includes the user device 204 determining, from the overlay data, one or more overlay properties. In some examples, determining the one or more overlay properties may include extracting those properties from the overlay data.

At block 908, the process 900 includes the user device 204 changing the map view from the first version to a second version based on the one or more overlay properties.

In some examples, the overlay properties may define a two-dimensional feature. In this example, block 908 of changing the map view from the first version to the second version may include changing the map view from an enhanced state to a diminished state that presents the two-dimensional feature in a two-dimensional map. In some examples, the two-dimensional feature may include a two-dimensional polyline. The overlay data may further include a set of navigation instructions corresponding to the two-dimensional polyline.

In some examples, the overlay properties may define a three-dimensional feature. In this example, block 908 of changing the map view from the first version to the second version may include changing the map view from a diminished state to an enhanced state that displays the three-dimensional feature in a three-dimensional map.

In some examples, the overlay properties may define a two-dimensional feature. In this example, block 908 of changing the map view from the first version to the second version may include adding the two-dimensional feature to the map view to present the two-dimensional feature in a three-dimensional map. In some examples, the two-dimensional feature may include a two-dimensional polyline. The overlay data may further include a set of navigation instructions corresponding to the two-dimensional polyline.

In some examples, the overlay data may include a three-dimensional feature. In this example, block 908 of changing the map view from the first version to the second version may include adding the three-dimensional feature to the map view to present the three-dimensional feature in a three-dimensional map.

In some examples, the overlay may include a two-dimensional feature and the map view may include a three-dimensional map. In this example, changing the map view from the first version to the second version may include projecting the two-dimensional feature onto the three-dimensional the map view.

In some examples, block 908 of changing the map view from the first version to the second version based on the one or more overlay properties may include changing a portion of the map view. The one or more overlay properties may identify coordinates of the overlay. In some examples, the portion may include a single map tile corresponding to the overlay. In some examples, block 908 of changing the portion of the map view may include changing the portion of the map view that intersects with the overlay without changing other portions of the map view that do not intersect with the overlay.

In some examples, block 908 of changing the map view from the first version to the second version based on the one or more overlay properties may include changing an entirety of the map view.

In some examples, block 908 of changing the map view from the first version to the second version may include removing or adding one or more three-dimensional features based at least in part on the one or more overlay properties.

At block 910, the process 900 includes the user device 204 rendering, on the display of the user device, a second version of the map view, the second version including the overlay. In some examples, the first version of the map view may include a three-dimensional map and the second version may include a two-dimensional map. In some examples, the overlay may include one or more annotations. In this example, block 910 of rendering the second version of the map view may include rendering the one or more annotations in the map view.

In some examples, block 910 of rendering the second version of the map view may include rendering the second version in accordance with the map configuration data.

In some examples, the process 900 may further include removing the overlay from the second version of the map view, and changing the map view from the second version to the first version based at least in part on removing the overlay from the second version.

FIG. 10 illustrates an example architecture or environment 1000 configured to implement techniques described herein, according to at least one example. The architecture 1000 includes a user device 1006 (e.g., the user device 204) and a service provider computer 1002 (e.g., the service provider 206). In some examples, the example architecture 1000 may further be configured to enable the user device 1006 and the service provider computer 1002 to share information. In some examples, the devices may be connected via one or more networks 1008 (e.g., via Bluetooth, WiFi, the Internet). In some examples, the service provider computer 1002 may be configured to implement at least some of the techniques described herein with reference to the user device 1006 and vice versa.

In some examples, the networks 1008 may include any one or a combination of many different types of networks, such as cable networks, the Internet, wireless networks, cellular networks, satellite networks, other private and/or public networks, or any combination thereof. While the illustrated example represents the user device 1006 accessing the service provider computer 1002 via the networks 1008, the described techniques may equally apply in instances where the user device 1006 interacts with the service provider computer 1002 over a landline phone, via a kiosk, or in any other manner. It is also noted that the described techniques may apply in other client/server arrangements (e.g., set-top boxes), as well as in non-client/server arrangements (e.g., locally stored applications, peer-to-peer configurations).

As noted above, the user device 1006 may be any type of computing device such as, but not limited to, a mobile phone, a smartphone, a personal digital assistant (PDA), a laptop computer, a desktop computer, a thin-client device, a tablet computer, a wearable device such as a smart watch, or the like. In some examples, the user device 1006 may be in communication with the service provider computer 1002 via the network 1008, or via other network connections.

In one illustrative configuration, the user device 1006 may include at least one memory 1014 and one or more processing units (or processor(s)) 1016. The processor(s) 1016 may be implemented as appropriate in hardware, computer-executable instructions, firmware, or combinations thereof. Computer-executable instructions or firmware implementations of the processor(s) 1016 may include computer-executable or machine-executable instructions written in any suitable programming language to perform the various functions described. The user device 1006 may also include geo-location devices (e.g., a global positioning system (GPS) device or the like) for providing and/or recording geographic location information associated with the user device 1006. In some examples, the processors 1016 may include a GPU and a CPU.

The memory 1014 may store program instructions that are loadable and executable on the processor(s) 1016, as well as data generated during the execution of these programs. Depending on the configuration and type of the user device 1006, the memory 1014 may be volatile (such as random access memory (RAM)) and/or non-volatile (such as read-only memory (ROM), flash memory). The user device 1006 may also include additional removable storage and/or non-removable storage 1026 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 1014 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 1014 and the additional storage 1026, both removable and non-removable, are all examples of non-transitory computer-readable storage media. For example, non-transitory computer-readable storage media may include volatile or non-volatile, removable or non-removable media implemented in any method or technology for storage of information such as computer-readable instructions, data structures, program modules, or other data. The memory 1014 and the additional storage 1026 are both examples of non-transitory computer-storage media. Additional types of computer-storage media that may be present in the user device 1006 may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 1006. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The user device 1006 may also contain communications connection(s) 1028 that allow the user device 1006 to communicate with a data store, another computing device or server, user terminals, and/or other devices via the network 1008. The user device 1006 may also include I/O device(s) 1030, such as a keyboard, a mouse, a pen, a voice input device, a touch screen input device, a display, speakers, and a printer.

Turning to the contents of the memory 1014 in more detail, the memory 1014 may include an operating system 1012 and/or one or more application programs or services for implementing the features disclosed herein such as applications 1011 (e.g., client applications 214, native map application 212, web application, etc.) and map engine 1013 (e.g., the map engine 210). At least some techniques described with reference to the service provider computer 1002 may be performed by the user device 1006 and vice versa.

The service provider computer 1002 may also be any type of computing device such as, but not limited to, a collection of virtual or “cloud” computing resources, a remote server, a mobile phone, a smartphone, a PDA, a laptop computer, a desktop computer, a thin-client device, a tablet computer, a wearable device, a server computer, or a virtual machine instance. In some examples, the service provider computer 1002 may be in communication with the user device 1006 via the network 1008, or via other network connections.

In one illustrative configuration, the service provider computer 1002 may include at least one memory 1042 and one or more processing units (or processor(s)) 1044. The processor(s) 1044 may be implemented as appropriate in hardware, computer-executable instructions, firmware, or combinations thereof. Computer-executable instructions or firmware implementations of the processor(s) 1044 may include computer-executable or machine-executable instructions written in any suitable programming language to perform the various functions described.

The memory 1042 may store program instructions that are loadable and executable on the processor(s) 1044, as well as data generated during the execution of these programs. Depending on the configuration and type of service provider computer 1002, the memory 1042 may be volatile (such as RAM) and/or non-volatile (such as ROM and flash memory). The service provider computer 1002 may also include additional removable storage and/or non-removable storage 1046 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 1042 may include multiple different types of memory, such as SRAM, DRAM, or ROM. While the volatile memory described herein may be referred to as RAM, any volatile memory that would not maintain data stored therein, once unplugged from a host and/or power, would be appropriate. The memory 1042 and the additional storage 1046, both removable and non-removable, are both additional examples of non-transitory computer-readable storage media.

The service provider computer 1002 may also contain communications connection(s) 1048 that allow the service provider computer 1002 to communicate with a data store, another computing device or server, user terminals, and/or other devices via the network 1008. The service provider computer 1002 may also include I/O device(s) 1050, such as a keyboard, a mouse, a pen, a voice input device, a touch input device, a display, speakers, and a printer.

Turning to the contents of the memory 1042 in more detail, the memory 1042 may include an operating system 1052 and/or one or more application programs 1041 or services for implementing the features disclosed herein.

In the following, further examples are described to facilitate the understanding of the present disclosure.

Example 1. In this example, there is provided a computer-implemented method, including:
requesting a surface texture corresponding to a map tile visible in a map view, the surface texture defining a rendering target for presenting a graphical overlay in connection with the map tile, the surface texture being shared via a shared memory;
drawing the graphical overlay into the surface texture using the shared memory to define an overlay surface texture that includes the graphical overlay; and
providing the overlay surface texture for presenting the graphical overlay in the map tile in the map view.

Example 2. In this example, there is provided a computer-implemented method of any of the preceding or subsequent examples, further including receiving a request to add the graphical overlay to the map view.

Example 3. In this example, there is provided a computer-implemented method of any of the preceding or subsequent examples, further including requesting the graphical overlay from an overlay source.

Example 4. In this example, there is provided a computer-implemented method of any of the preceding or subsequent examples, wherein the overlay source includes a remote server.

Example 6. In this example, there is provided a computer-implemented method of any of the preceding or subsequent examples, wherein the overlay source is the same as a source of the map tile.

Example 6. In this example, there is provided a computer-implemented method of any of the preceding or subsequent examples, wherein the graphical overlay includes overlay graphics including a series of frames.

Example 7. In this example, there is provided a computer-implemented method of any of the preceding or subsequent examples, wherein the shared memory is a memory of a user device that is shared between a graphics processing unit of the user device and a central processing unit of the user device.

Example 8. In this example, there is provided a computer-implemented method of any of the preceding or subsequent examples, wherein the shared memory is a memory of a user device that is shared by a client application and a map engine.

Example 9. In this example, there is provided a computer-implemented method of any of the preceding or subsequent examples, wherein providing the overlay surface texture includes providing the overlay surface texture to a map engine on a user device, the map engine configured to render the graphical overlay on top of the map tile.

Example 10. In this example, there is provided a computer-implemented method of any of the preceding or subsequent examples, wherein providing the overlay surface texture includes providing the overlay surface texture to a map engine on a user device, the map engine configured to blend the graphical overlay with the map tile.

Example 11. In this example, there is provided a computer-implemented method of any of the preceding or subsequent examples, wherein the graphical overlay includes vector data.

Example 12. In this example, there is provided a computer-implemented method of any of the preceding or subsequent examples, wherein the graphical overlay includes raster data.

Example 13. In this example, there is provided a computer-implemented method of any of the preceding or subsequent examples, wherein requesting the surface texture includes requesting, by a client application on a user device, the surface texture from a map engine accessible on the user device.

Example 14. In this example, there is provided a computer-implemented method of any of the preceding or subsequent examples, wherein the graphical overlay includes a portion of a graphical animation.

Example 15. In this example, there is provided a computer-implemented method of any of the preceding or subsequent examples, wherein a ratio of surface textures to map tiles is 1:1.

Example 16. In this example, there is provided a computer-implemented method of any of the preceding or subsequent examples, wherein the surface texture is a first surface texture, the map tile is a first map tile, the rendering target is a first rendering target, and the graphical overlay includes a first portion and a second portion, the method further including requesting a second surface texture corresponding to a second map tile visible in the map view, the second surface texture defining a second rendering target for presenting a second portion of the graphical overlay in connection with the second map tile.

Example 17. In this example, there is provided a computer-implemented method of any of the preceding or subsequent examples, wherein drawing the graphical overlay into the surface texture includes drawing the second portion of the graphical overlay into the second surface texture using the shared memory to define a second overlay surface texture that includes the second portion of the graphical overlay.

Example 18. In this example, there is provided a computer-implemented method of any of the preceding or subsequent examples, wherein providing the overlay surface texture for presenting the graphical overlay includes providing the second overlay surface texture for presenting the second portion of the graphical overlay in the second map tile in the map view.

Example 19. In this example, there is provided a computer-implemented method of any of the preceding or subsequent examples, wherein providing the overlay surface texture includes providing the overlay surface texture to a map engine of a user device, the map engine configured to use the overlay surface texture to draw the graphical overlay on the map tile in the map view.

Example 20. In this example, there is provided one or more non-transitory computer-readable media including computer-executable instructions that, when executed by one or more processors, cause the one or more processors to perform the method of any one of examples 1-19.

Example 21. In this example, there is provided a computerized system, including:
a memory configured to store computer-executable instructions; and
a processor configured to access the memory and execute the computer-executable instructions to perform the method of any one of examples 1-19.

Example 22. In this example, there is provided a computer-implemented method, including:
providing a surface texture corresponding to a map tile visible in a map view, the surface texture defining a rendering target for presenting a graphical overlay in connection with the map tile, the surface texture accessible via a shared memory;
accessing an overlay surface texture defined by a client application drawing the graphical overlay into the surface texture using the shared memory, the overlay surface texture including the graphical overlay; and
presenting the graphical overlay in connection with the map tile in the map view using the overlay surface texture.

Example 23. In this example, there is provided a computer-implemented method of any of the preceding or subsequent examples, wherein the map tile is one of a plurality of map tiles visible in the map view, and wherein individual surface textures are provided for each of the plurality of map tiles.

Example 24. In this example, there is provided a computer-implemented method of any of the preceding or subsequent examples, wherein the surface texture is hardware-accelerated.

Example 25. In this example, there is provided a computer-implemented method of any of the preceding or subsequent examples, the shared memory is shared between a map engine and a client application.

Example 26. In this example, there is provided a computer-implemented method of any of the preceding or subsequent examples, wherein the shared memory is shared between a graphics processing unit and a central processing unit.

Example 27. In this example, there is provided a computer-implemented method of any of the preceding or subsequent examples, wherein presenting the graphical overlay in connection with the map tile in the map view using the overlay surface texture includes rendering the graphical overlay using the overlay surface texture.

Example 28. In this example, there is provided a computer-implemented method of any of the preceding or subsequent examples, wherein presenting the graphical overlay in connection with the map tile in the map view using the overlay surface texture includes blending the graphical overlay using the overlay surface texture.

Example 29. In this example, there is provided a computer-implemented method of any of the preceding or subsequent examples, further including receiving a request for the surface texture, wherein providing the surface texture includes providing the surface texture in response to receiving the request.

Example 30. In this example, there is provided a computer-implemented method of any of the preceding or subsequent examples, wherein receiving the request includes receiving the request, by a map engine of a user device, from a client application of the user device.

Example 31. In this example, there is provided a computer-implemented method of any of the preceding or subsequent examples, further including receiving a request to add the graphical overlay to the map view, wherein providing the surface texture includes providing the surface texture in response to receiving the request to add the graphical overlay.

Example 32. In this example, there is provided a computer-implemented method of any of the preceding or subsequent examples, wherein the request is based on a user input received by a user device.

Example 33. In this example, there is provided a computer-implemented method of any of the preceding or subsequent examples, wherein the graphical overlay includes overlay graphics including a series of frames.

Example 34. In this example, there is provided a computer-implemented method of any of the preceding or subsequent examples, wherein the graphical overlay includes vector data.

Example 35. In this example, there is provided a computer-implemented method of any of the preceding or subsequent examples, wherein providing the surface texture includes providing, by a map engine accessible on a user device, the surface texture to a client application of the user device.

Example 36. In this example, there is provided a computer-implemented method of any of the preceding or subsequent examples, wherein presenting the graphical overlay includes rendering the graphical overlay on the map tile using overlay surface texture.

Example 37. In this example, there is provided a computer-implemented method of any of the preceding or subsequent examples, wherein the overlay surface texture is defined by the client application using one or more programmable shaders.

Example 38. In this example, there is provided one or more non-transitory computer-readable media including computer-executable instructions that, when executed by one or more processors, cause the one or more processors to perform the method of any one of examples 22-37.

Example 39. In this example, there is provided a computerized system, including:
a memory configured to store computer-executable instructions; and
a processor configured to access the memory and execute the computer-executable instructions to perform the method of any one of examples 22-37.

Example 40. In this example, there is provided a computer-implemented method, including:
determining a first version of a map view to render on a display of a user device based at least in part on map configuration data;
receiving overlay data for rendering an overlay on the map view;
determining, from the overlay data, one or more overlay properties;
changing the map view from the first version to a second version based on the one or more overlay properties; and
rendering, on the display of the user device, a second version of the map view, the second version including the overlay.

Example 41. In this example, there is provided a computer-implemented method of any of the preceding or subsequent examples, wherein the first version of the map view includes a three-dimensional map and the second version includes a two-dimensional map.

Example 42. In this example, there is provided a computer-implemented method of any of the preceding or subsequent examples, wherein receiving the overlay data includes receiving the overlay data from a third-party source.

Example 43. In this example, there is provided a computer-implemented method of any of the preceding or subsequent examples, wherein the overlay properties define a two-dimensional feature, and wherein changing the map view from the first version to the second version includes changing the map view from an enhanced state to a diminished state that presents the two-dimensional feature in a two-dimensional map.

Example 44. In this example, there is provided a computer-implemented method of any of the preceding or subsequent examples, wherein the two-dimensional feature includes a two-dimensional polyline, and the overlay data further includes a set of navigation instructions corresponding to the two-dimensional polyline.

Example 45. In this example, there is provided a computer-implemented method of any of the preceding or subsequent examples, wherein the overlay properties define a three-dimensional feature, and wherein changing the map view from the first version to the second version includes changing the map view from a diminished state to an enhanced state displays the three-dimensional feature in a three-dimensional map environment.

Example 46. In this example, there is provided a computer-implemented method of any of the preceding or subsequent examples, wherein receiving the overlay data includes receiving the overlay data from a mapping service.

Example 47. In this example, there is provided a computer-implemented method of any of the preceding or subsequent examples, wherein the overlay properties define a two-dimensional feature, and wherein changing the map view from the first version to the second version includes adding the two-dimensional feature to the map view to present the two-dimensional feature in a three-dimensional map environment.

Example 48. In this example, there is provided a computer-implemented method of any of the preceding or subsequent examples, wherein the two-dimensional feature includes a two-dimensional polyline, and the overlay data further includes a set of navigation instructions corresponding to the two-dimensional polyline.

Example 49. In this example, there is provided a computer-implemented method of any of the preceding or subsequent examples, wherein the overlay data includes a three-dimensional feature, and wherein changing the map view from the first version to the second version includes adding the three-dimensional feature to the map view to present the three-dimensional feature in a three-dimensional map.

Example 50. In this example, there is provided a computer-implemented method of any of the preceding or subsequent examples, wherein overlay includes one or more annotations, and wherein rendering the second version of the map view includes rendering the one or more annotations in the map view.

Example 51. In this example, there is provided a computer-implemented method of any of the preceding or subsequent examples, wherein the overlay includes a two-dimensional feature and the map view includes a three-dimensional map, wherein changing the map view from the first version to the second version includes projecting the two-dimensional feature onto the three-dimensional.

Example 52. In this example, there is provided a computer-implemented method of any of the preceding or subsequent examples, wherein receiving the overlay data includes receiving a user selection of the overlay for presentation in the map view.

Example 53. In this example, there is provided a computer-implemented method of any of the preceding or subsequent examples, wherein rendering the second version of the map view includes rendering the second version in accordance with the map configuration data.

Example 54. In this example, there is provided a computer-implemented method of any of the preceding or subsequent examples, wherein changing the map view from the first version to the second version based on the one or more overlay properties includes changing a portion of the map view, the one or more overlay properties identifying coordinates of the overlay.

Example 55. In this example, there is provided a computer-implemented method of any of the preceding or subsequent examples, wherein the portion includes a single map tile corresponding to the overlay.

Example 56. In this example, there is provided a computer-implemented method of any of the preceding or subsequent examples, wherein changing the portion of the map view includes changing the portion of the map view that intersects with the overlay without changing other portions of the map view that do not intersect with the overlay.

Example 57. In this example, there is provided a computer-implemented method of any of the preceding or subsequent examples, wherein changing the map view from the first version to the second version based on the one or more overlay properties includes changing an entirety of the map view.

Example 58. In this example, there is provided a computer-implemented method of any of the preceding or subsequent examples, further including:
removing the overlay from the second version of the map view; and
changing the map view from the second version to the first version based at least in part on removing the overlay from the second version.

Example 59. In this example, there is provided a computer-implemented method of any of the preceding or subsequent examples, wherein changing the map view from the first version to the second version includes removing or adding one or more three-dimensional features based at least in part on the one or more overlay properties.

Example 60. In this example, there is provided one or more non-transitory computer-readable media including computer-executable instructions that, when executed by one or more processors, cause the one or more processors to perform the method of any one of examples 40-59.

Example 61. In this example, there is provided a computerized system, including:
a memory configured to store computer-executable instructions; and
a processor configured to access the memory and execute the computer-executable instructions to perform the method of any one of examples 40-59.

The various examples can be further implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracle Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, keypad), and at least one output device (e.g., a display device, printer, speaker). Such a system may also include one or more storage devices, such as disk drives, optical storage devices, and solid-state storage devices such as RAM or ROM, as well as removable media devices, memory cards, flash cards, etc.

Such devices can also include a computer-readable storage media reader, a communications device (e.g., a modem, a network card (wireless or wired), an infrared communication device), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used and/or particular elements might be implemented in hardware, software (including portable software, such as applets), or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

As described above, one aspect of the present technology is the gathering and use of data available from various sources to provide a comprehensive and complete window to a user's personal health record. The present disclosure contemplates that in some instances, this gathered data may include personally identifiable information (PII) data that uniquely identifies or can be used to contact or locate a specific person. Such personal information data can include demographic data, location-based data, telephone numbers, email addresses, Twitter IDs, home addresses, data or records relating to a user's health or level of fitness (e.g., vital sign measurements, medication information, exercise information), date of birth, health record data, or any other identifying or personal or health information.

The present disclosure recognizes that the use of such personal information data, in the present technology, can be used to the benefit of users. For example, the personal information data can be used to provide enhancements to a user's experience with mapping services. Further, other uses for personal information data that benefit the user are also contemplated by the present disclosure.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the U.S., collection of or access to certain health data may be governed by federal and/or state laws, such as the Health Insurance Portability and Accountability Act (HIPAA); whereas health data in other countries may be subject to other regulations and policies and should be handled accordingly. Hence, different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services or other services relating to health record management, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

1-61. (canceled)

62. A computer-implemented method, comprising:
determining a first version of a map view to render on a display of a user device based at least in part on map configuration data;
receiving overlay data for rendering an overlay on the map view;
determining, from the overlay data, one or more overlay properties;
changing the map view from the first version to a second version based on the one or more overlay properties; and
rendering, on the display of the user device, a second version of the map view, the second version including the overlay.

63. The computer-implemented method of claim 62, wherein the first version of the map view comprises a three-dimensional map and the second version comprises a two-dimensional map.

64. The computer-implemented method of claim 62, wherein receiving the overlay data comprises receiving the overlay data from a third-party source.

65. The computer-implemented method of claim 64, wherein the overlay properties define a two-dimensional feature, and wherein changing the map view from the first version to the second version comprises changing the map view from an enhanced state to a diminished state that presents the two-dimensional feature in a two-dimensional map.

66. The computer-implemented method of claim 65, wherein the two-dimensional feature comprises a two-dimensional polyline, and the overlay data further comprises a set of navigation instructions corresponding to the two-dimensional polyline.

67. The computer-implemented method of claim 64, wherein the overlay properties define a three-dimensional feature, and wherein changing the map view from the first version to the second version comprises changing the map view from a diminished state to an enhanced state displays the three-dimensional feature in a three-dimensional map environment.

68. The computer-implemented method of claim 62, wherein receiving the overlay data comprises receiving the overlay data from a mapping service.

69. The computer-implemented method of claim 68, wherein the overlay properties define a two-dimensional feature, and wherein changing the map view from the first version to the second version comprises adding the two-dimensional feature to the map view to present the two-dimensional feature in a three-dimensional map environment.

70. The computer-implemented method of claim 69, wherein the two-dimensional feature comprises a two-dimensional polyline, and the overlay data further comprises a set of navigation instructions corresponding to the two-dimensional polyline.

71. The computer-implemented method of claim 68, wherein the overlay data comprises a three-dimensional feature, and wherein changing the map view from the first version to the second version comprises adding the three-dimensional feature to the map view to present the three-dimensional feature in a three-dimensional map.

72. The computer-implemented method of claim 62, wherein overlay comprises one or more annotations, and wherein rendering the second version of the map view comprises rendering the one or more annotations in the map view.

73. The computer-implemented method of claim 62, wherein the overlay comprises a two-dimensional feature and the map view comprises a three-dimensional map, wherein changing the map view from the first version to the second version comprises projecting the two-dimensional feature onto the three-dimensional.

74. The computer-implemented method of claim 62, wherein changing the map view from the first version to the second version based on the one or more overlay properties comprises changing an entirety of the map view; or
removing or adding one or more three-dimensional features based at least in part on the one or more overlay properties.

75. The computer-implemented method of claim 62, further comprising:
removing the overlay from the second version of the map view; and
changing the map view from the second version to the first version based at least in part on removing the overlay from the second version.

76. One or more non-transitory computer-readable media comprising computer-executable instructions that, when executed by one or more processors of a computer system, cause the computer system to perform operations, comprising:
determining a first version of a map view to render on a display of a user device based at least in part on map configuration data;
receiving overlay data for rendering an overlay on the map view;
determining, from the overlay data, one or more overlay properties;
changing the map view from the first version to a second version based on the one or more overlay properties; and
rendering, on the display of the user device, a second version of the map view, the second version including the overlay.

77. The one or more non-transitory computer-readable media of claim 76, wherein changing the map view from the first version to the second version based on the one or more overlay properties comprises changing a portion of the map view, the one or more overlay properties identifying coordinates of the overlay.

78. The one or more non-transitory computer-readable media of claim 77, wherein the portion comprises a single map tile corresponding to the overlay.

79. The one or more non-transitory computer-readable media of claim 77, wherein changing the portion of the map view comprises changing the portion of the map view that intersects with the overlay without changing other portions of the map view that do not intersect with the overlay.

80. A device, comprising:
a memory configured to store computer-executable instructions; and
a processor configured to access the memory and execute the computer-executable instructions to at least:
determine a first version of a map view to render on a display of the device based at least in part on map configuration data;
receive overlay data for rendering an overlay on the map view;
determine, from the overlay data, one or more overlay properties;
change the map view from the first version to a second version based on the one or more overlay properties; and
render, on the display of the device, a second version of the map view, the second version including the overlay.

81. The device of claim 80, wherein receiving the overlay data comprises receiving a user selection of the overlay for presentation in the map view.
